(19) United States
(12) Patent Application Publication
(10) Pub. No.: US 2003/0033989 A1
(43) Pub. Date: Feb. 20, 2003

(54) Animal restraint apparatus

(76) Inventor: Geoffrey J. Kreutzer, Hazeldean via Kilcoy (AU)

Correspondence Address: Renner, Otto, Boisselle & Sklar, LLP, 19th Floor, 1621 Euclid Avenue, Cleveland, OH, 44115, US

(21) Appl. No.: 10/199,843

(22) Filed: Jul. 19, 2002

(30) Foreign Application Priority Data
Jul. 23, 2001 (AU) 55908/01

(51) Int. Cl. A01K 27/00

(52) U.S. Cl. 119/856

(57) ABSTRACT

An animal restraint apparatus for a horse has a pair of attachment members which attach around an animal's front legs, at least one elongate member which is attached relative to each attachment member, and an biasing portion, the elongate member being supported by a portion of the animal which is behind the front legs of the animal, the biasing portion functioning to pull the animal's leg back into a rest position should the animal push its leg forward.

### FIELD OF THE INVENTION

This invention is directed to an animal restraint apparatus and is particularly directed to an improved type of hobble for horses. The invention need not however be limited to its use on horses.

### BACKGROUND ART

Horses are sometimes hobbled in order to keep the horse in a particular place. Hobbles are well known and typically comprise a pair of straps which extend about the horses front legs and the straps being interconnected either by a hobble chain or by another strap. The hobble chain or interconnecting strap is fairly short which means that the horse can only move about 40 cm at a time.

A disadvantage with conventional hobbles is that the horse can injure itself by falling over, tripping and the like by virtue of its front legs being held together by the hobble. If the horse is an expensive racehorse, an injury can be quite undesirable.

Some horses become particularly distressed when hobbled using conventional hobbles and can rub their front legs raw trying to remove the hobble.

When transporting horses in a horse float, it is sometimes desirable to hobble the horse to prevent the horse from moving about in the horse float which can cause the towing vehicle to lose control. However, in a horse float there is a particularly high-risk that the horse will stumble, trip or fall when hobbled due to the movement of the horse float during transportation.

For this reason, hobbles do not find great acceptance amongst racehorse owners, and conventional hobbles can be irritating to the horse, can cause injury to the horse, and therefore suffer from a number of disadvantages.

### OBJECT OF THE INVENTION

The present invention is directed to a hobble which functions in a manner quite different to conventional hobbles in that the horses front legs are not directly interconnected to each other via an interconnecting strap or chain as is the case with conventional hobbles. Instead, the hobble is such that the horses front legs are restrained by being connected via the hobble to a rear part of the horse.

It is an object of the invention to provide an animal restraint apparatus which may overcome at least some of the abovementioned disadvantages or provide the public with a useful or commercial choice.

In one form, the invention resides in an animal restraint apparatus which comprises a pair of attachment members which attach around an animal's front legs, at least one elongate member which is attached relative to each attachment member, and an biasing portion, the elongate member being supported by a portion of the animal which is behind the front legs of the animal, the biasing portion functioning to pull the animal's leg back into a rest position should the animal push its leg forward.

In this manner, the restraint apparatus differs from conventional hobbles in that the strap member does not directly couple the two leg attachments to each other. Instead, the strap member couples a leg attachments to a rear part of the animal. The biasing portion provides a biasing action to pull the animal's leg back into the normally rest position should the animal push its leg forwardly.

The apparatus has a pair of attachment members. The attachment members attach around the front legs of the animal with one attachment member on one leg and the other attachment member on the other leg. The attachment members may comprise a strap, band, a line member or any other type of attachment member which can attach about the animal's leg. In the embodiment, the attachment members comprise flexible straps. The straps may be cushioned on the inside surface to protect the animal's leg. The straps may be length adjustable and this can be achieved by any suitable means including a buckle, Velcro and the like. If desired, the attachment members may be elasticised to fit snugly about the animal's leg.

It is expected that the attachment members will fit about the animal's leg and above the animal's knee.

The apparatus has an elongate member. The elongate member typically comprises a strap, band or like flexible member. The elongate member may be attached to, or relative to one or more of the attachment members. Suitably, the elongate member is indirectly attached to the attachment members via the biasing portion. One or more elongate members can be provided.

In one form, the elongate member can have a length sufficient to allow it to pass about the rear of the animal. Preferably, the elongate member has a length sufficient to pass from one attachment member, about the rear of the animal and to the other attachment member. In this manner, the elongate member functions to attach the two attachment members relative to each other but via a rear portion of the animal.

The biasing portion may be positioned at any suitable place on the apparatus. Suitably, the biasing portion is positioned between the elongate member and the attachment member. Thus, a pair of biasing portions may be provided. The biasing portion may comprise an elastic member. Alternatively, the biasing portion may comprise a spring.

The “strength” of the biasing portion may be varied to provide a stronger or weaker bias to the apparatus. Thus, for a particularly unruly animal, a stronger biasing portion may be provided. It is envisaged that the biasing portion may be removable from the apparatus to allow it to be changed with other biasing portions having different “strengths”. Alternatively, the apparatus may be designed to allow more than one biasing portion to be attached to vary the bias.

A support means may be provided to prevent the elongate member from being “stepped out of” by the animal. The support means may comprise a girth band and the like. The girth band may be length adjustable by any suitable means.

The apparatus couples or attaches the animal's front legs to a rear portion of the animal. While this can be achieved by having the elongate member extending about the animal, other embodiments are also envisaged. For instance, the elongate member can be attached to a girth band, or to any other member which is on the horse. It is envisaged that the elongate member may also be attached to a rear leg of the horse.

In another form of the invention, the apparatus may be attached to, or form part of a covering for the animal. For instance, a horse blanket could form part of the apparatus and the attachment members could be attached to the horse blanket, preferably via a biasing means. An elongate member may be provided between the attachment member and the covering. Alternatively, the covering (eg horse blanket) could be provided with a pair of flaps or extension members and the like to which the attachment members can be connected either directly, or indirectly and via the biasing means. In any event, the invention should be construed broadly. It is also envisaged that the apparatus may include any type of device, piece or member which can be attached to the horse and which can form an anchor point for the elongate member, or which can include elongate portions or any other type of portion to connect directly or indirectly to the attachment members.

### BRIEF DESCRIPTION OF THE DRAWINGS

An embodiment of the invention will be described with reference to the following drawings in which:

FIG. 1 illustrates an animal restraint apparatus according to an embodiment of the invention.

FIG. 2 illustrates the animal restraint apparatus attached to a horse.

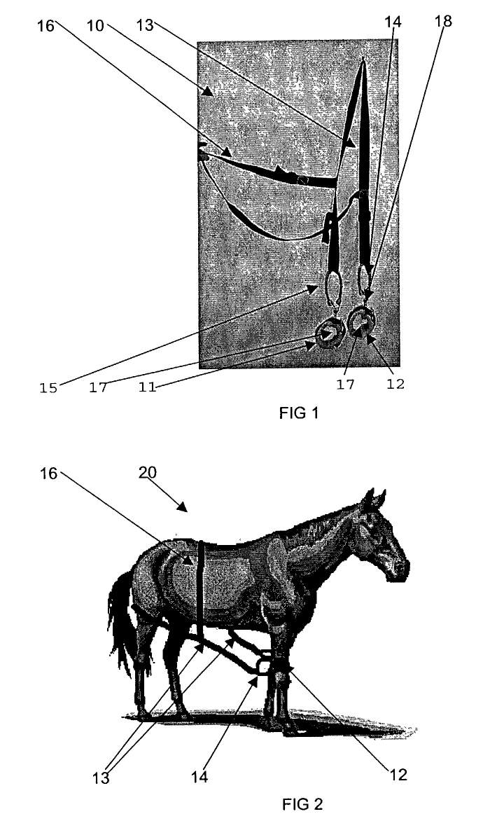

### BEST MODE

Referring to the figures, there is illustrated an animal restraint apparatus which finds particulars suitability as a horse hobble. Apparatus 10 comprises a pair of attachment members 11, 12 an elongate flexible member 13, biasing means 14, 15 and a support means 16. More specifically, attachment members 11, 12 are designed to attach about the front legs of a horse. The attachment members comprise flexible leather straps which are length adjustable via a buckle, Velcro or any other suitable means. The inside of each attachment member is lined with a cushioning material 17 to provide a comfortable fit about the legs of a horse.

Attached to each attachment member is a biasing means 14, 15. In the embodiment, the biasing means comprises an elasticised strap or rope. The elasticised strap or rope has a loop shape configuration and is attached to each attachment member via a catch 18.

The elongate flexible member 13 comprises a webbing strap. The strap is looped at one end to accommodate the elasticised strap or rope which forms the biasing means 14, 15. Member 13 has a length of between 3-5 m to allow it to pass behind the horse. The length of member 13 can of course be varied to suit. Moreover, the length of member 14 can be adjusted by any suitable means including via a buckle, and the like.

Referring to FIG. 2 the fitting of the restraint apparatus is illustrated. Flexible member 13 extends from adjacent one attachment member 12 about the rear end of the horse 20 and to the other attachment member 11. Specifically, the flexible member attaches to each biasing means 14, 15.

To prevent flexible member 13 from falling to the ground, a support member 16 is provided. In the embodiment, support member 16 is a girth band which extends over the horses back and attaches to each side of flexible member 13. The girth band can be formed of any suitable material and is usually adjustable in length.

Once the restraint apparatus has been attached to a horse, if the horse moves a front leg forwardly, it will cause pressure to be applied to the rear end of the horse, and the biasing means 14, 15 will bias the front leg back to the rest position. In practice, it is found that the apparatus is extremely effective in preventing the horse from pawing the ground, or moving away. However, there is little likelihood that the horse will stumble or fall over as the front legs are not connected directly to each other as is the case with conventional hobbles. The horse finds the apparatus comfortable to wear and there is little likelihood that the apparatus will injure the horse. The apparatus can be attached to a horse prior to a race to prevent the horse from pawing the ground (and using up energy). The apparatus should also prevent the horse from undesirable movement in a horse float.

1. An animal restraint apparatus which comprises a pair of attachment members which attach around an animal's front legs, at least one elongate member which is attached relative to each attachment member, and an elastic biasing portion, the elongate member being supported by a portion of the animal which is behind the front legs of the animal, the elastic biasing portion functioning to pull the animal's leg back into a rest position should the animal push its leg forward.

2. The apparatus of claim 1, wherein the attachment members is selected from a strap, band, or a line member.

3. The apparatus as claimed in claim 2, wherein the attachment members comprise straps which are cushioned on the inside surface to protect the animal's leg.

4. The apparatus as claimed in claim 2, wherein the straps are length adjustable.

5. The apparatus as claimed in any one of the preceding claims, wherein the elongate member are selected from a strap, band or a flexible member.

6. The apparatus as claimed in claim 5, wherein the elongate member is indirectly attached to the attachment members via the biasing portion.

7. The apparatus as claimed in claim 6, wherein the elongate member has a length sufficient to allow it to pass about the rear of the animal.

8. The apparatus as claimed in claim 7, wherein the elongate member has a length sufficient to pass from one attachment member, about the rear of the animal and to the other attachment member.

9. The apparatus as claimed in claim 1, wherein the biasing portion is positioned between the elongate member and the attachment member.

10. The apparatus as claimed in claim 9, wherein the biasing portion comprises an elastic member in the form of a loop

11. The apparatus as claimed in claim 1, wherein a support means is provided to prevent the elongate member from being stepped out of by the animal.

12. The apparatus as claimed in claim 11, wherein the support means comprises a girth band.
